(19) United States
(12) Patent Application Publication
(10) Pub. No.: US 2010/0205238 A1
(43) Pub. Date: Aug. 12, 2010

(54) METHODS AND APPARATUS FOR INTELLIGENT EXPLORATORY VISUALIZATION AND ANALYSIS

(75) Inventors: Nan Cao, Xi'An City (CN); David H. Gotz, Purdys, NY (US); Peter Kissa, Ossining, NY (US); Shi Xia Liu, ShangDi Beijing (CN); Jie Lu, Hawthorne, NY (US); Wei Hong Qian, Beijing (CN); Zhen Wen, Chappaqua, NY (US); Michelle Zhou, Briarcliff Manor, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 12/367,132

(22) Filed: Feb. 6, 2009

(51) Int. Cl. G06F 15/16; G06F 17/30

(52) U.S. Cl. 709/203; 715/733; 707/E17.108

(57) ABSTRACT

Methods and apparatus are provided for intelligent exploratory visualization and analysis. A semantics-based client-server application architecture is provided that enables interactive visualization and analysis applications over the web. From the client perspective, user activities are observed and the client determines if a sequence of user activities comprises one or more predefined semantics-based user actions. Semantics-based action descriptor are then sent to the server, optionally with any related parameters, and a response is then received from the server. From the server perspective, one or more semantics-based action descriptors are received from the client with an action type selected from a predefined set of types, wherein the semantics-based action descriptors are based on a sequence of activities of a user. The server processes the semantics-based action descriptors and sends a response to the client in response to the one or more semantics-based action descriptors.

### FIELD OF THE INVENTION

The present invention relates to client-server application architectures and, more particularly, to semantics-based client-server application architectures that enable interactive visualization and analysis applications over the web.

### BACKGROUND OF THE INVENTION

A “thin client” is client software in a client-server architecture that depends primarily on a remote server for processing activities. Primarily, a thin client passes input and output between the user and the remote server. A rich client, on the other hand, does as much processing as possible locally on the client machine and, typically, executes without any remote server component. Many thin client devices are browser-based and most processing is performed by the server. In this manner, a thin client architecture allows client devices to obtain and execute a wide variety of software applications without the cost or complexity of installing individual copies of expensive software on each user's machine.

At the same time, businesses are creating and storing more data than ever before. Recognizing that valuable insights are contained in this information, companies have begun to encourage the use of visualization to drive their business decision-making processes. Moreover, companies want to empower all of their employees to take part in such a process.

A number of applications exist to help users view, explore, and analyze information. However, such tools are either (1) rich-client applications that are expensive and difficult to maintain, or (2) thin-client applications that lack sufficient functionality due to architectural limitations.

A need exists for a semantics-based client-server application architecture that enables interactive visualization and analysis applications over the web.

### SUMMARY OF THE INVENTION

Generally, methods and apparatus are provided for intelligent exploratory visualization and analysis. According to one aspect of the invention, a semantics-based client-server application architecture is provided that enables interactive visualization and analysis applications over the web. From the client perspective, user activities, such as keystrokes and other user inputs, are observed and the client determines if a sequence of user activities comprises one or more predefined semantics-based user actions. Semantics-based action descriptor are then sent to the server, optionally with any related parameters, and a response is then received from the server. The client may be comprised, for example, of one or more interface modules and a central client-side coordinator.

From the server perspective, one or more semantics-based action descriptors are received from the client with an action type selected from a predefined set of types, wherein the semantics-based action descriptors are based on a sequence of activities of a user. The server processes the semantics-based action descriptors and sends a response to the client in response to the one or more semantics-based action descriptors. The server may be comprised, for example, of an action tracking component, a query manager, and a visualization recommender.

A more complete understanding of the present invention, as well as further features and advantages of the present invention, will be obtained by reference to the following detailed description and drawings.

### BRIEF DESCRIPTION OF THE DRAWINGS

FIG. 1 is a schematic block diagram of a visualization and analysis system incorporating features of the present invention;

FIG. 2 is an exemplary graphical user interface illustrating a number of exemplary user interaction areas;

FIG. 3 is a sample table summarizing a number of exemplary distinct action types;

FIG. 4 illustrates an exemplary taxonomy for classifying user actions;

FIGS. 5 and 6 are block diagrams of a server side platform and client side platform, respectively, that can implement the processes of the present invention;

FIG. 7 is a flow chart describing an exemplary implementation of the processes executed by the client side coordinator; and

FIG. 8 is a flow chart describing an exemplary implementation of the processes executed by the server side coordinator.

### DETAILED DESCRIPTION OF THE PREFERRED EMBODIMENTS

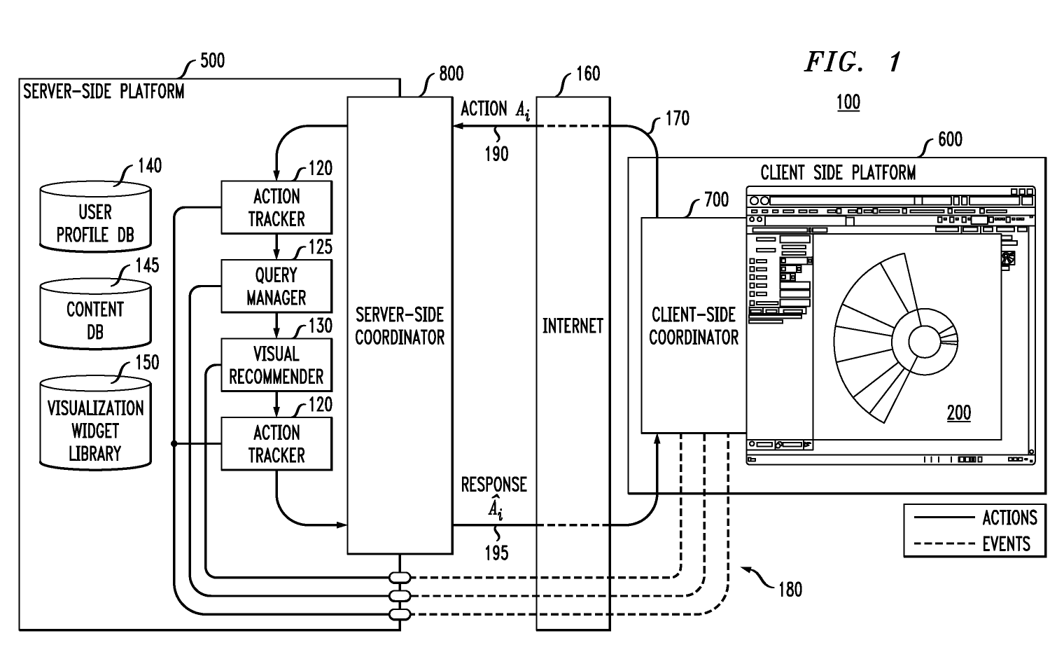

The present invention provides a visualization and analysis system 100, shown in FIG. 1. As discussed further below, the exemplary visualization and analysis system 100 is a web-based, client-server system built on top of standard web technologies.

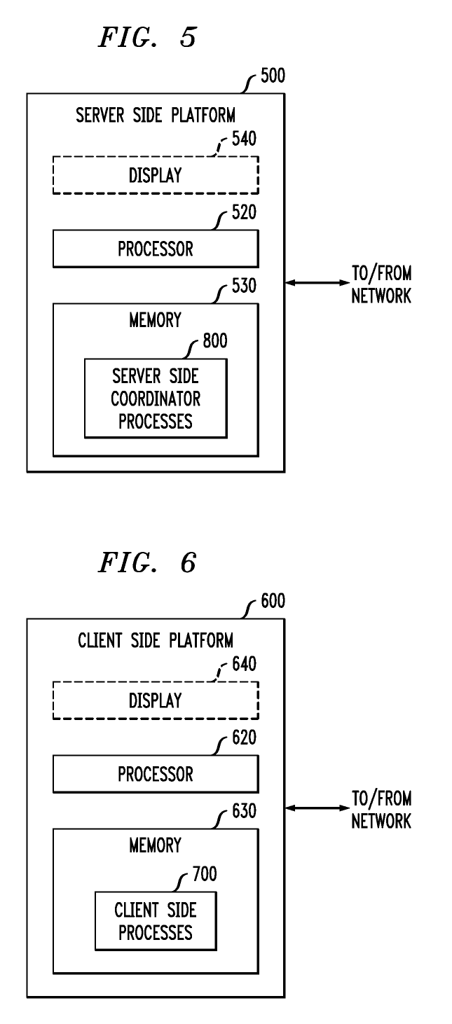

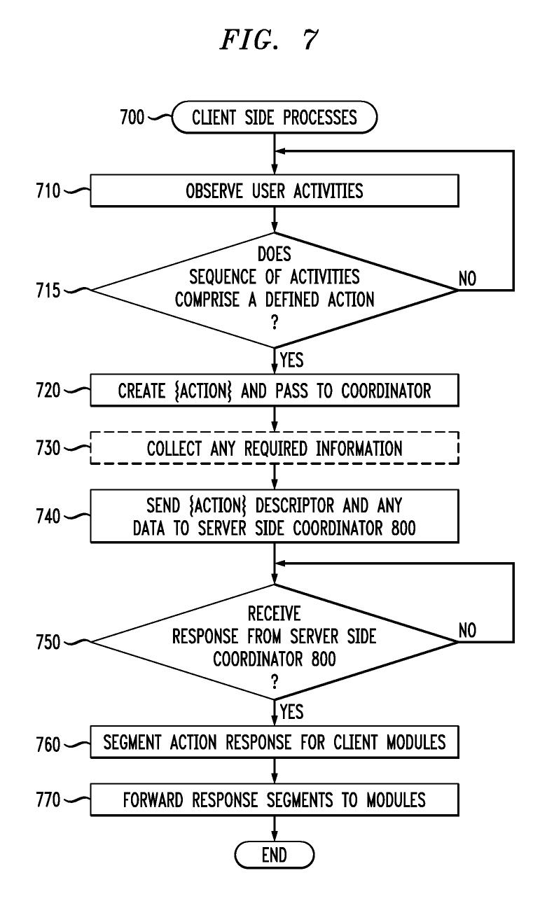

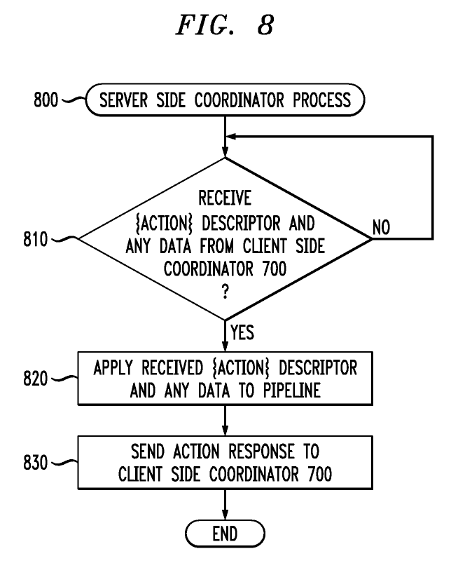

FIG. 1 is a schematic block diagram of a visualization and analysis system 100 incorporating features of the present invention. As shown in FIG. 1, the exemplary visualization and analysis system 100 comprises a server side platform 500, discussed below in conjunction with FIG. 5, and a client side platform 600, discussed below in conjunction with FIG. 6. The server side platform 500 contains a server side coordinator 800, discussed below in conjunction with FIG. 8, as well as an action tracker 120, a query manager 125, and a visual recommender 130. These components interact with a user profile database 140, a content database 145 and a visualization widget library 150. The client side platform 600 contains a client side coordinator 700, discussed below in conjunction with FIG. 7. The exemplary server side platform 500 and client side platform 600 communicate over a network such as, for example, the Internet 160.

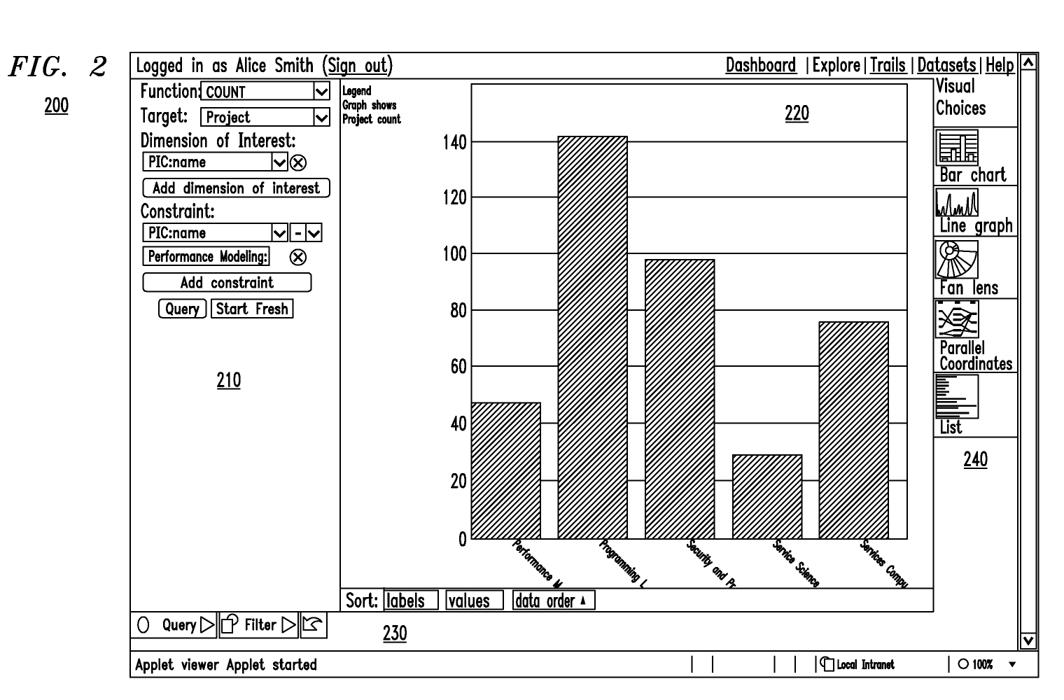

The exemplary client side platform 600 employs a browser-based graphical user interface 200. FIG. 2 is an exemplary graphical user interface 200 illustrating a number of exemplary user interaction areas. As shown in FIG. 2, the exemplary graphical user interface 200 provides a query panel 210 for issuing data queries, a visualization canvas 220 for displaying user-requested information, and a history panel 230 where a user can view and modify his or her ongoing exploration path. For additional details on exemplary visualization types that can be employed in the visualization canvas 220, see U.S. patent application Ser. No. 12/194,657, entitled “Methods and Apparatus for Visual Recommendation Based on User Behavior,” incorporated by reference herein. For additional details on action trails that are presented in the history panel 230, see U.S. patent application Ser. No. 12/198,964, entitled “Methods and Apparatus for Obtaining Visual Insight Provenance of a User,” incorporated by reference herein.

In one exemplary embodiment, given a user's input in any of the three areas 210, 220, 230, a request is first routed to the client side coordinator 700. Depending on the type of user interaction, the coordinator 700 triggers one of two exemplary client-server communication paths in the visualization and analysis system 100: an action loop 170 or an event loop 180, as shown in FIG. 1. The exemplary action loop 170 is the primary client-server communication path in the visualization and analysis system 100. As discussed below in conjunction with FIG. 8, once an action reaches the server side platform 500, the exemplary action loop 170 involves the action tracker 120, query manager 125 and visual recommender 130 within the server side platform 500.

Generally, the query manager 125 is responsible for interpreting and executing user queries for information (e.g., by translating to and executing SQL queries to databases). Once query results are obtained, the visual recommender 130 then selects the proper visualization to encode the retrieved data. Depending on the quality of the data, it may also decide to transform the data (e.g., normalization) for better visualization. The visual recommender 130 can be based, for example, on the teachings of U.S. patent application Ser. No. 12/194,657, entitled “Methods and Apparatus for Visual Recommendation Based on User Behavior,” incorporated by reference herein.

Once a visual response is created, it is then sent back to the client-side coordinator 700 to eventually update the visual canvas. The action tracker 120 observes and logs user actions 190 and the corresponding response 195 of the system 100. As discussed further below, the action tracker 120 records each incoming action 190 and parameters of key responses 195, such as action type, parameters, time of execution and position in sequence of performed actions. The action tracker 120 attempts to dynamically infer a user's higher-level semantic constructs (e.g., action patterns) from the recorded user actions to capture a user's insight provenance and assist in visualization recommendation. The action tracker 120 may be based, for example, on the teachings of U.S. patent application Ser. No. 12/198,964, entitled “Methods and Apparatus for Obtaining Visual Insight Provenance of a User,” incorporated by reference herein.

In contrast, events are triggered by lower-level, intermediate user interactions. For example, the action loop 170 transmits a query action as a whole but not the intermediate query building steps, such as clicking a button to add a new constraint in the query panel 210. These intermediate steps are considered events. When an event requires the attention of a server-side module, the event loop 180 provides a shortcut between the client and individual server-side components (the dotted lines in FIG. 1). For example, after the user clicks a button to a new contstraint to the query panel, an event may request a list of context-appropriate query prompts from the server. Given this event, the event loop 180 involves only the query manager 125 on the server side. The event loop 180 allows the visualization and analysis system 100 to quickly satisfy intermediate needs without the overhead of involving all of the server components, as done in the action loop 170.

As discussed further below in conjunction with FIG. 7, the client side coordinator 700 may optionally gather data before forwarding an action to the server 500. For example, a bookmark action triggered in the action tracker 230 is sent to the client-side coordinator 700, which can gather visualization state and a thumbnail from the visualization canvas 220. The bookmark action is sent with a bundle of parameters gathered from both the visualization canvas 220 (e.g., thumbnail and visualization state) and the action tracker 230 (e.g., user supplied annotation for the bookmark). In addition, the client side coordinator 700 may distribute the data in an action response received from the server 500 to the appropriate client-side modules 210, 220, 230, 240. For example, a response 195 to a query action arrives at the client side coordinator 700. The response 195 is partitioned and distbibuted to the query panel 210 to update the current constraints, the visualization canvas 220 to update the visualization, the recommendation panel 240 to update the recommendation, and the action trail display 230 to update the depiction of the user's exploration path.

User Actions

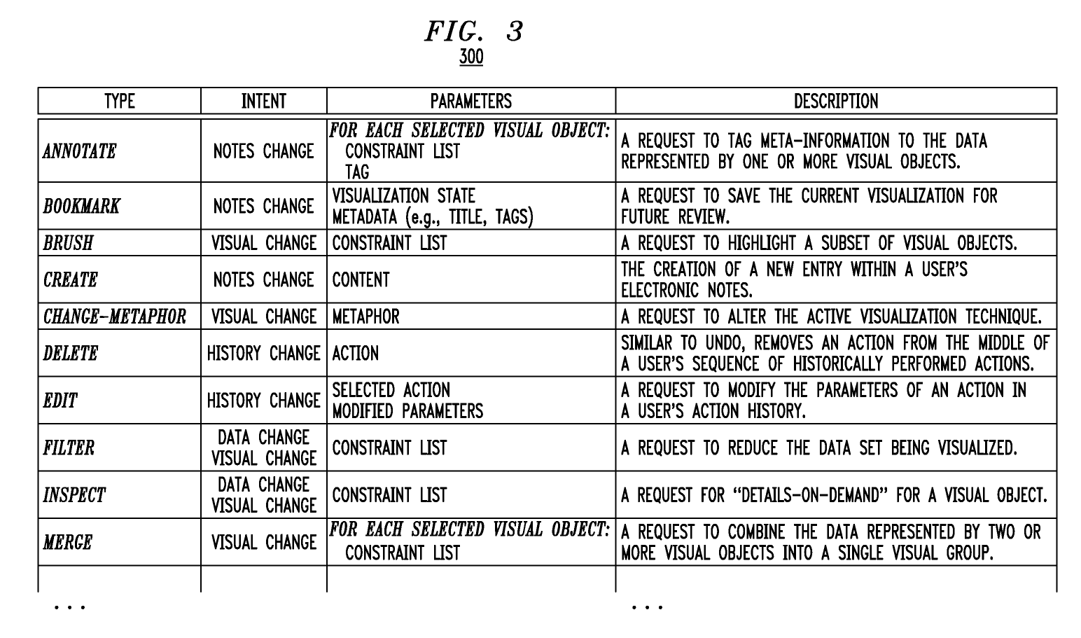

An “action” represents an atomic, semantic step taken by a user in his or her visual analytic process. As discussed hereinafter, each action has a type (e.g., query or filter) that represents a user's specific analytic intention and a set of parameters (e.g., data concepts and constraints in a query action). FIG. 3 is a sample table 300 summarizing a number of exemplary distinct action types. For each action 190, the table 300 includes a formal definition (type, intent, and parameters) as well as a brief description. Each action 190 is described using one or more intents based on the primary user motivation. Four distinct intents are used in the exemplary embodiment: (1) data change, (2) visual change, (3) notes change, and (4) history change.

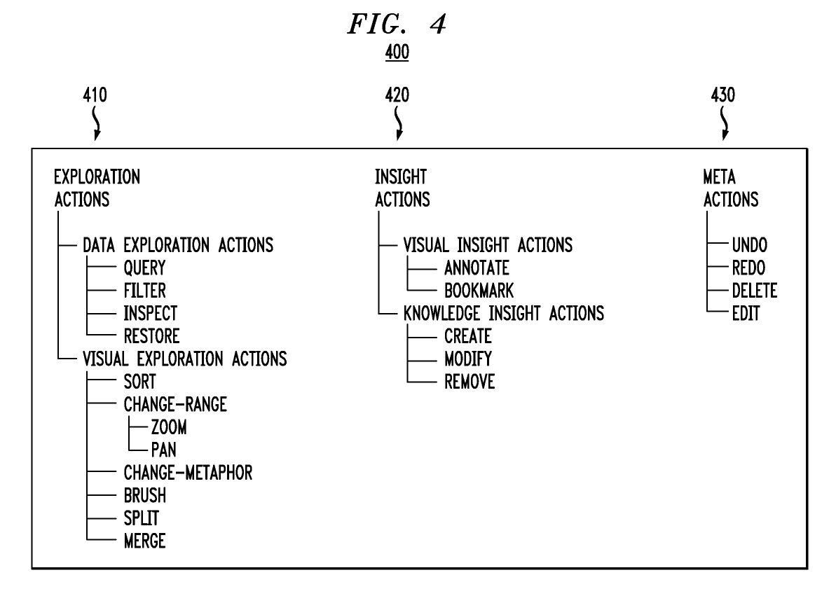

FIG. 4 illustrates an exemplary taxonomy 400 for classifying user actions 190. As shown in FIG. 4, the exemplary taxonomy 400 comprises three classes of actions, namely, exploration actions 410, insight actions 420 and meta actions 430. The action types of FIG. 3 and the action taxonomy 400 of FIG. 4 are discussed further in U.S. patent application Ser. No. 12/198,964, entitled “Methods and Apparatus for Obtaining Visual Insight Provenance of a User,” incorporated by reference herein. Generally, the classes 410, 420, 430 are used as the basis for inferring higher-level sub-tasks from a sequence of user performed actions. In addition, the taxonomy 400 serves as a guideline for others to expand the set of actions within the characterization. Exploration actions 410 are performed as users access and explore data in search of new insights. Insight actions 420 are performed by users as they discover or manipulate the insights obtained over the course of an analysis. Meta actions 430, such as Undo and Redo, do not operate on the data set or the visual presentation, but rather on the user's action history itself.

Example Project and Flow

Consider an organization that maintains a large wiki site describing ongoing research projects. Each project page is a semi-structured text document, containing a project description, the people working on the project, and several other important pieces of information. New projects are added to the wiki regularly, and updates are constantly contributed by people related to a project, including project members and managers. While it is relatively easy to look up information about individual projects in the wiki, there is no easy way to obtain a quick overview of a collection of projects. Yet in many cases, higher-level summaries of information may be most valuable.

Consider a researcher who is putting together a new proposal for a computer vision research project. To help prepare the proposal, she would like to analyze all the existing projects first. To scope the project properly, for example, the researcher must decide how many “person-years” (PYs) could be realistically funded. To help answer this question, the researcher would like to view the distribution of PYs in funded projects, focusing on those in the area of computer vision. Similarly, the researcher could better position his or her proposal if she could discover which funding programs were historically most likely to accept computer vision proposals. In addition, the researcher would like to identify potential collaboration partners by examining related projects and their team information.

The information required to answer each of the researcher's questions is contained within the project wiki. However, there is no easy way for the researcher to extract the needed insights. To help such researchers, the disclosed visualization and analysis system 100 provides an intuitive set of tools to perform visual analysis tasks and obtain insights. The visualization and analysis system 100 provides a visual analysis interface 200 that provides full access to query 210, visualization 220, and history management 230 tools. The user first uses the query panel 210 to build a query.

Once the query is submitted, the client forwards a new Query action to the server 500. On the server side, the action is processed by three core components: (1) the query manager 125 interprets the GUI input to formulate a SQL query and then executes it, (2) the visualization recommender 130 automatically composes a visualization encoding the retrieved data, and (3) the action tracker 120 records the Query action as part of the user's insight provenance. The server 500 forwards a response to the client 600, which is updated accordingly to reflect the newly created visualization in the canvas 220, the newly recorded Query action in the history panel 230, a new set of visualization recommendations 240, and the new set of data constraints and parameters on the query panel 210.

The system-generated visualizations not only present users with the requested information, they also serve as an input mechanism for users to further their data exploration. For example, a user can select visual objects in the visualization that correspond to particular areas in which the user is interested. Once the areas are selected, the user can issue a filter action using a context-sensitive menu. In response to this action, the visualization and analysis system 100 executes the Filter action and updates the visualization to reflect the user's new data interests. Both the query and history panels 210, 230 are also updated to reflect the new data constraints and the Filter action, respectively. The visualization and analysis system 100 supports context-sensitive queries and dynamically recommends appropriate visualizations in context.

In addition to automatically composing a top-recommended visualization, the visualization and analysis system 100 can optionally provide users with a set of alternative views. The alternatives can be displayed, for example, as thumbnails in a window 240 next to the visualization canvas 220. A user can click on any thumbnail to switch to the alternative visualization.

Whenever a user action (e.g., query and filter) is performed, the visualization and analysis system 100 updates its internal semantic representation of the user's insight provenance. Externally, the performed action is displayed in the history panel 230 so that the user can manipulate or reuse collections of past actions as visual analysis macros.

To return to work at a later time or to preserve insightful views of data, a user can optionally bookmark his or her work at any point of the analysis. Each bookmark in the visualization and analysis system 100 records the visualization state, as well as the associated exploration path that leads to the saved point in time (referred to as a user's analytic trail). In addition to revisiting saved trails, a user can also share trails with co-workers or re-purpose saved trails for new tasks.

Client/Server Systems

FIGS. 5 and 6 are block diagrams of a server side platform 500 and client side platform 600, respectively, that can implement the processes of the present invention. As shown in FIGS. 5 and 6, memories 530, 630 configure the respective processors 520, 620 to implement the methods, steps, and functions disclosed herein (collectively, shown as server side coordinator proceses 800 in FIG. 5 and client side coordinator processes 700 in FIG. 6). The memories 530, 630 could be distributed or local and the processors 520, 620 could be distributed or singular. The memories 530, 630 could be implemented as electrical, magnetic or optical memories, or any combination of these or other types of storage devices. It should be noted that each distributed processor that makes up processors 520, 620 generally contain their own addressable memory space. It should also be noted that some or all of computer systems 500, 600 can be incorporated into a personal computer, laptop computer, handheld computing device, application-specific circuit or general-use integrated circuit.

Client/Server Processes

As previously indicated, the client side platform 600 executes one or more processes associated with a client side coordinator 700. FIG. 7 is a flow chart describing an exemplary implementation of the processes executed by the client side coordinator 700. Generally, the flow chart in FIG. 7 illustrates how the client side coordinator 700 processes user actions, such as queries or bookmarks. As shown in FIG. 7, the client side coordinator 700 initially observes user activities, during step 710, such as keystrokes and other user inputs via the graphical user interface 200. During step 715, the client side coordinator 700 determines if a sequence of such user actions comprises a predefined semantics-based user action. For example, for a query, the user fills out the query template 210 and clicks submit. As previously indicated, in the action loop, all communications occur using the taxonomy 400 of FIG. 4 containing standard action types (e.g., query) that are known to all components.

The semantics-based action is created during step 720 and passed by the appropriate module, such as the query module, to the Coordinator 700. In addition, if any additional information is required for the action, it is optionally collected during step 730.

In an exemplary embodiment, the tasks described by steps 710, 715 and 720 may be performed by individual client-side modules, such as modules 210, 220, 230, 240. The client side coordinator does not observe low-level user activites like clicks. Thus, the modules 210, 220, 230, 240 observe low level activity and then report actions to the client side coordinator 700 during step 720 at the action level, such as Query/Filter/Zoom. The client side coordinator 700 then decides what to do based on the type of the action.

Thereafter, during step 740, the action descriptor and any data are sent to the server side coordinator 800. The process 700 then waits for a response from the server side coordinator 800 during step 750. Once the response is received from the 800, the client side coordinator 700 segments the recevied action responses for the appropriate client modules during step 760.

Finally, the client side coordinator 700 forwards the response segments to the modules during step 770, before program control repeats from step 710.

As previously indicated, the server side platform 500 executes one or more processes associated with a server side coordinator 800. FIG. 8 is a flow chart describing an exemplary implementation of the processes executed by the server side coordinator 800. Generally, the flow chart in FIG. 8 illustrates how the server side coordinator 800 processes user actions, such as queries or bookmarks, that are received from the client side coordinator 700.

As shown in FIG. 8, the server side coordinator 800 is initiated during step 810 upon receipt of an action descriptor and any associated data from the client side coordinator 700. Thereafter, the server side coordinator 800 applies the received action descriptor and any data to the pipeline 120, 125, 130, during step 820.

The server side coordinator 800 then sends the action response, for example, as an XML fragment, to the client side coordinator 700 during step 830.

It is noted that events are not processed by the server side coordinator 800. An event is sent directly by the appropriate client-side module or client-side coordinator 700 to a server-side event loop handler for the appropriate server-side module. The event is handled independently by the action tracker module 120, for example, by doing a lookup against the user profile if the user has requested details about a particular action. An event response is delivered directly to the requesting component.

Conclusion

While a number of figures show an exemplary sequence of steps, it is also an embodiment of the present invention that the sequence may be varied. Various permutations of the algorithm are contemplated as alternate embodiments of the invention.

While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware. Such software may be employed in, for example, a digital signal processor, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

The visualization and analysis system 100 comprises memory and a processor that can implement the processes of the present invention. Generally, the memory configures the processor to implement the visual recommendation processes described herein. The memory could be distributed or local and the processor could be distributed or singular. The memory could be implemented as an electrical, magnetic or optical memory, or any combination of these or other types of storage devices. It should be noted that each distributed processor that makes up the processor generally contains its own addressable memory space. It should also be noted that some or all of visualization analysis system 100 can be incorporated into a personal computer, laptop computer, handheld computing device, application-specific circuit or general-use integrated circuit.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

What is claimed is:

1. A method for communicating between a client and a server in a browser-based application environment, comprising:
observing user activities;
determining if a sequence of user activities comprises one or more predefined semantics-based user actions;
sending a semantics-based action descriptor to said server; and
receiving a response from said server in response to said semantics-based action descriptor.

2. The method of claim 1, wherein said user activities comprise at least one of keystrokes and other user inputs.

3. The method of claim 1, further comprising the steps of determining if a predefined user event has occurred and sending an event descriptor to said server.

4. The method of claim 1, wherein the client is comprised of one or more interface modules and a central client-side coordinator.

5. The method of claim 1, wherein said browser-based application environment is a visualization analysis application that comprises one or more of a visualization canvas, a query module, a visualization recommendation canvas, and an action tracking component.

6. The method of claim 1, wherein said step of sending said semantics-based action descriptor further comprises the step of sending one or more parameters related to said predefined semantics-based user action.

7. The method of claim 1, further comprising the step of a client-side coordinator obtaining additional data from one or more other interface components.

8. A method for communicating between a client and a server in a browser-based application environment, comprising:
receiving one or more semantics-based action descriptors from said client with an action type selected from a predefined set of types, wherein said semantics-based action descriptors are based on a sequence of activities of a user;
processing said semantics-based action descriptors; and
sending a response to said client in response to said one or more semantics-based action descriptors.

9. The method of claim 8, wherein said activities of said user comprise at least one of keystrokes and other user inputs.

10. The method of claim 8, wherein said step of receiving said semantics-based action descriptors further comprises the step of receiving one or more parameters related to said predefined semantics-based user action type.

11. The method of claim 8, wherein said processing step processes each of said predefined semantics-based action descriptors through a process based on a semantic type of said corresponding predefined semantics-based action.

12. The method of claim 8, wherein said server comprises one or more of an action tracking component, a query manager, and a visualization recommender.

13. The method of claim 12, wherein said action tracking component, based on a type of action reported, builds a logical model of a visual analysis behavior of said user.

14. The method of claim 12, wherein said query module executes one or more queries against a data store.

15. The method of claim 12, wherein said visualization recommender specifies one or more visualization types to be employed.

16. The method of claim 12, wherein said action tracker records said response to each processed action.

17. The method of claim 8, wherein said response sent to said client includes one or more individual client response fragments produced by one or more stages in said server.

18. The method of claim 1, further comprising the steps of receiving an event descriptor from said client, wherein said event descriptor is processed by a particular module in said server.

19. A client device, comprising:
a memory; and
at least one processor, coupled to the memory, operative to:
observe user activities;
determine if a sequence of user activities comprises one or more predefined semantics-based user actions;
send a semantics-based action descriptor to said server; and
receive a response from said server in response to said semantics-based action descriptor.

20. A server device, comprising:
a memory; and
at least one processor, coupled to the memory, operative to:
receive one or more semantics-based action descriptors from said client with an action type selected from a predefined set of types, wherein said semantics-based action descriptors are based on a sequence of activities of a user;
process said semantics-based action descriptors; and
send a response to said client in response to said one or more semantics-based action descriptors.
